(19) United States
(12) Patent Application Publication
(10) Pub. No.: US 2020/0087970 A1
(43) Pub. Date: Mar. 19, 2020

(54) SYSTEM AND METHOD FOR MANUALLY OR ELECTRONICALLY LOWERING AND RAISING HINGED TRAILER DOORS AND GATES

(71) Applicant: Bullet Proof Trailer Systems, LLC, Bountiful, UT (US)

(72) Inventors: Scott Nielson, St. George, UT (US); Wayne Provost, St. George, UT (US); Duran Anderson, Washington, UT (US)

(73) Assignee: Bullet Proof Trailer Systems, LLC, Bountiful, UT (US)

(21) Appl. No.: 16/576,325

(22) Filed: Sep. 19, 2019

Related U.S. Application Data
(60) Provisional application No. 62/733,424, filed on Sep. 19, 2018.

(51) Int. Cl. E05F 15/627; E05D 13/00; E05F 11/54; E05F 11/04; B65H 75/44

(52) U.S. Cl. CPC E05F 15/627; E05D 13/10; E05F 11/54; E05Y 2900/546; B65H 75/4431; E05Y 2900/516; E05F 11/04

(57) ABSTRACT

A trailer has a door coupled to the trailer via a hinge along the bottom of the door, a plurality of pulleys coupled to the trailer, at least one cable passing through the plurality of pulleys and tethered to the door, and a mechanism for releasing and withdrawing the cable through the pulleys, thereby actuating the door. The mechanism for releasing and withdrawing may be a hand crank, a motor, or both.

### CROSS-REFERENCE TO RELATED APPLICATIONS

This application claims the benefit of U.S. Provisional Application Ser. No. 62/733,424, filed on Sep. 19, 2018, which is incorporated herein by reference.

### TECHNICAL FIELD

The present disclosure relates to recreational vehicles (RVs), camp trailers, and other trailers. More particularly, the present disclosure relates to a system and method for manually or electronically lowering and raising hinged trailer doors and gates.

### BACKGROUND

Many trailers in the market today have a hinged door or gate that allows for easy access to the trailer. The hinged door may be lowered, allowing for a user to easily store large items (e.g., ATVs) therein during transport. Many open-bed trailers have such a gate, allowing a user to lower the gate, load equipment or vehicles, and then close the gate. These gates must be manually lowered and raised, which can be difficult for the elderly, handicapped, injured, weak, or others. As a result, a significant portion of the population are unable to avail themselves of the usefulness of these trailers.

Further, with the growing number of people that enjoy camping in a trailer and that have an ATV or UTV, there became a need for a camper trailer that was capable of hauling the ATV/UTV therein. These trailers are aptly termed “Toy Haulers” due to their ability to store ATVs/UTVs and have become quite popular in the market. To allow the loading and unloading of the ATV/UTV, the rear wall of the trailer is a hinged door. Currently in the art, a user will unlock the door and manually lower it by hand. When finished with the door, the user must then manually lift the door, hold it closed, and relock the door. Some trailers have cables that allow a user to secure the door horizontally, using cables, and use the door as a deck or extended living space. However, the door must be manually positioned, which can be difficult or impossible for many people to achieve.

Accordingly, there remains a need for a system and method that allows a user to lower and raise a hinged door/gate that does not require manual lifting and/or positioning of the gate. The present disclosure seeks to solve these and other problems.

### SUMMARY OF EXAMPLE EMBODIMENTS

In one embodiment, a trailer door actuation system comprises a door coupled to the trailer via a hinge along the bottom of the door, a plurality of pulleys coupled to the trailer, at least one cable passing through the plurality of pulleys and tethered to the door, and a mechanism for releasing and withdrawing the cable through the pulleys, thereby actuating the door. In one embodiment, the mechanism for releasing and withdrawing comprises a hand crank. In one embodiment, the mechanism for releasing and withdrawing comprises a motor.

In one embodiment, a trailer door actuation system comprises a door coupled to the trailer via a hinge along the bottom of the door, the door comprising a mechanism for releasing and withdrawing a cable mounted thereon. In one embodiment, the mechanism for releasing and withdrawing comprises a hand crank. In one embodiment, the mechanism for releasing and withdrawing comprises a motor. In one embodiment, the mechanism comprises a plurality of reels.

### BRIEF DESCRIPTION OF THE DRAWINGS

FIG. 1 is a rear elevation view of a trailer with the door lowered to a horizontal position;

FIG. 2 is a side elevation view of a trailer with the door lowered to a horizontal position;

FIG. 3 is a rear elevation view of a trailer with the door closed;

FIG. 4 is an example remote for controlling one or more motors;

FIG. 5 is a rear elevation view of a trailer with the door closed;

FIG. 6 is a side, detailed view of a door comprising pulleys and a hand crank;

FIG. 7 is a rear perspective view with the door in the horizontal position;

FIG. 8 is a rear elevation view of a trailer with the door closed;

FIG. 9 is a rear elevation view of a trailer with the door closed;

FIG. 10 is a side elevation view of a trailer with the door partially lowered;

FIG. 11 is a rear elevation view of a trailer with the door closed;

FIG. 12 is a detailed perspective view of a reel for winding a cable for lowering and raising the door;

FIG. 13 is a perspective view illustrating the use of a powered hand tool for actuating the reel; and

FIG. 14 is a detailed perspective view of a rotatable shaft of a trailer door actuation system.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a system and method that allows a user to lower and raise a hinged door/gate that does not require manual lifting and/or positioning of the gate. The system and method for manually or electronically lowering and raising hinged trailer doors and gates (the “trailer door actuation system”) described below solves these, and other, problems.

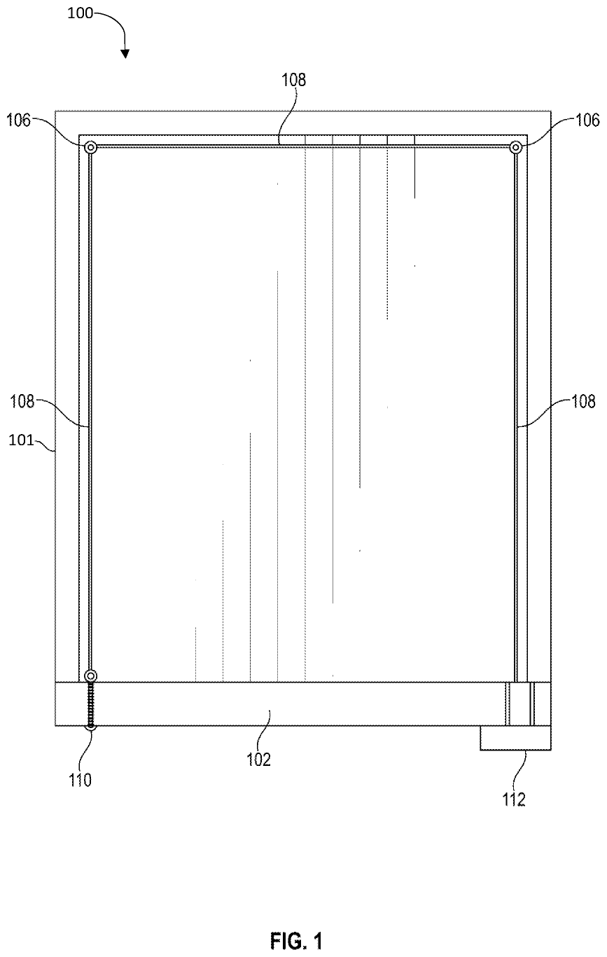

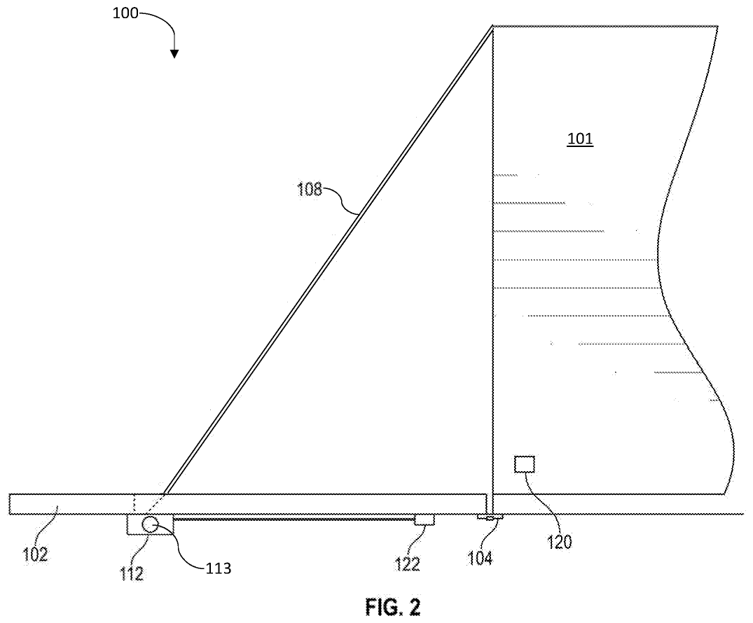

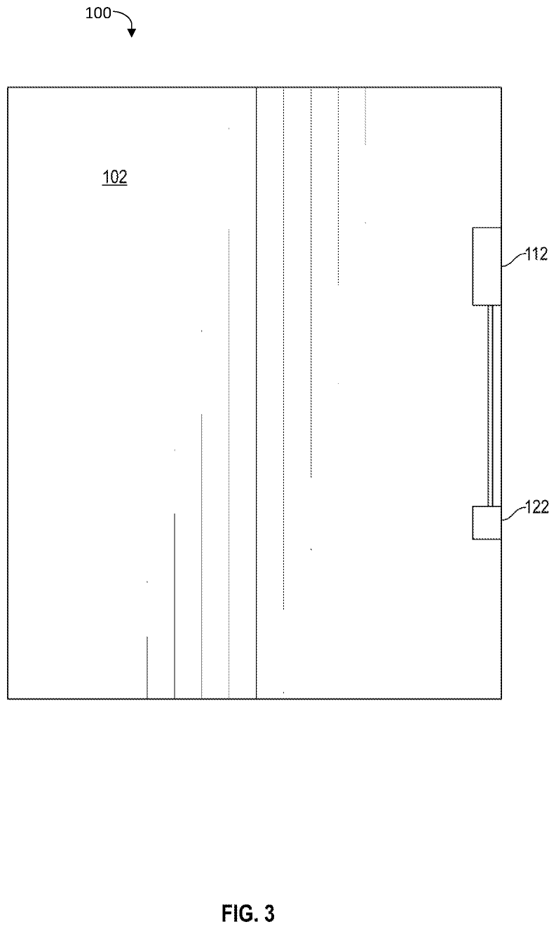

In one embodiment, as shown in FIGS. 1-4, a trailer 101 comprises a door 102 coupled to the trailer 101 via a hinge 104 along the bottom of the door 102. An example of this type of trailer is commonly referred to as a “Toy Hauler.” A trailer door actuation system 100 comprises a plurality of pulleys 106 coupled to the trailer 101, at least one cable 108 passing through the plurality of pulleys 106 and tethered to the door 102, such as by an eye bolt 110, and a mechanism for releasing and withdrawing the cable 108 through the pulleys 106, thereby actuating the door 102. As shown in FIGS. 1-4, in one embodiment, the mechanism for releasing and withdrawing comprises a motorized hoist 112. As best shown in FIG. 2, the motorized hoist 112 is coupled to the door 102. As the hoist 112 rotates in a first direction, the cable 108 is wound around the reel 113 of the hoist 112, thereby raising the door 102 to a closed position. As the hoist 112 rotates in a second direction, the cable 108 is unwound and released, thereby lowering the door 102 to the desired level. For example, the door 102 may be lowered to a horizontal position to function as a deck on the trailer 101 or may be lowered to the ground to function as a ramp for access to the trailer 101.

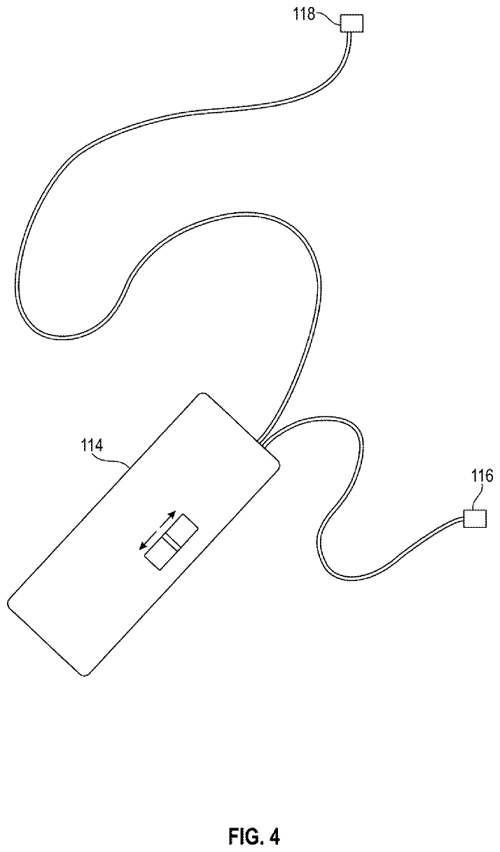

The motorized hoist 112 may be controlled using any standard switch known in the art. However, in one embodiment, the switch may comprise a remote 114 (FIG. 4) with a trailer connector 116 and a door connector 118. Accordingly, a user must electrically couple the trailer connector 116 to the trailer 101, such as by coupling the trailer connector 116 to a trailer receptacle 120 (FIG. 2), and must also couple the door connector 118 to the door 102, such as by coupling it to door receptacle 122. With both connectors 116, 118 engaged, the remote 114 may then be used to control the motorized hoist 112 and thereby raise or lower the door 102 to the desired position. It will be appreciated that this switch (i.e., the remote 114 and connectors 116, 118) also functions as a securing device. In other words, without this remote 114, the motorized hoist 112 cannot be actuated, thereby securing the door 102. This eliminates the requirement for padlocks or other methods or systems for securing the door 102 to prevent access. Further, the door 102 may be raised or lowered to any position by simply using the remote 114, which overcomes the manual lifting (of all doors and gates) and placement of cables (for deck-capable doors/gates) required by the prior art. While the example using the remote 114 had two connectors 116, 118, it will be appreciated that both are not required. For example, a single connector may be used in connection with the remote. In such an instance, power from the trailer would be supplied directly to the hoist 112, with the remote solely functioning as the switch for controlling the hoist 112. In other examples, a switch or remote may be mounted in or on the trailer 101, which may be secured using a locked cover or other means to prevent unwanted use. In other words, a user could unlock the cover (e.g., key, combination, etc.), lift the cover and access a switch, which may be in the form of buttons, toggles, a touch screen, or any other mechanism for controlling the motorized hoist 112.

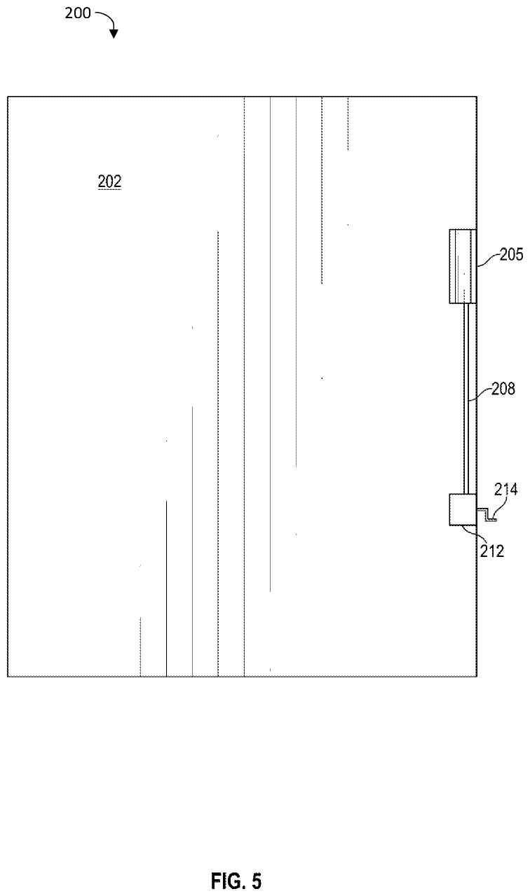

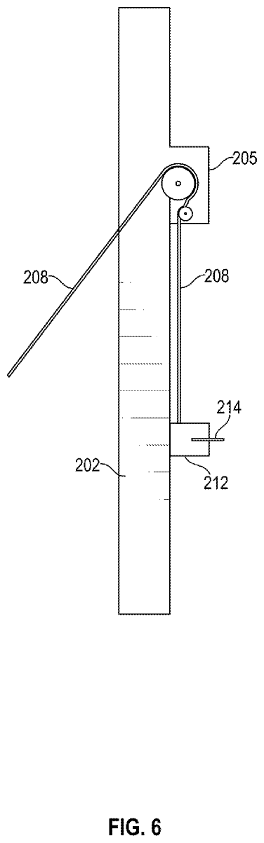

While motorized hoists may be preferable, they are not required. Accordingly, in one embodiment, as shown in FIGS. 5-6, a trailer door actuation system 200 comprises a manually actuated hoist 212 and a crank handle 214 functioning as the lever to actuate the hoist 212. The crank handle 214 may also be removable, thereby prohibiting use of the hoist 212 by unauthorized persons. As shown, the hoist 212 winds and unwinds cable 208, which passes through a door pulley system 205 and on to a plurality of pulleys on the trailer (not visible in this view) in the same manner as the pulleys 106 shown in FIG. 1. The door pulley system 205 allows the hoist 212 to be at a lower position on the door 202 where it remains easily accessible to a user, and keeps the cable straight for the hoist 212. In yet another embodiment, the trailer door actuation system 200 may comprise both a motor and a hand crank. This would allow a user the ability to raise and lower the gate even when power is not available, such as when the trailer is not connected to power and the trailer batteries have been overly drained.

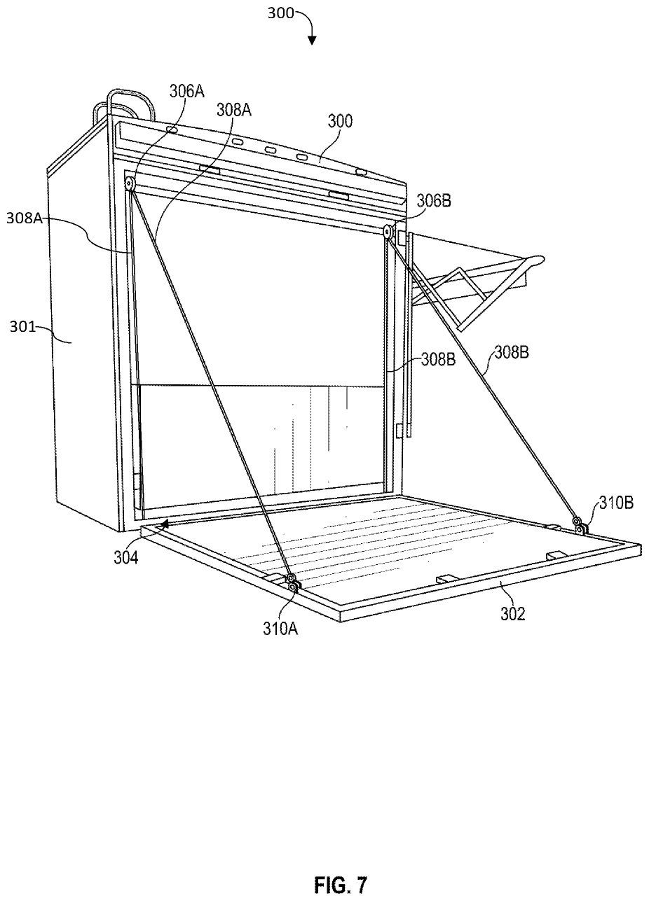

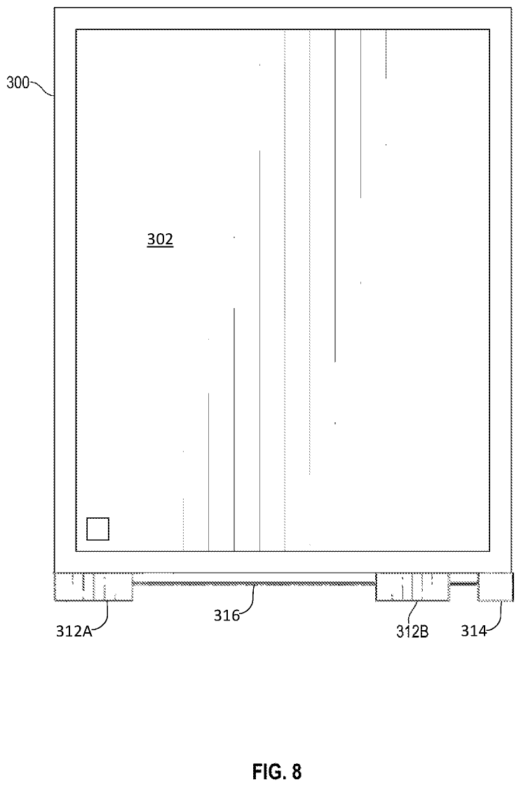

In one embodiment, as shown in FIGS. 7-8, a trailer 301 comprises a door 302 coupled to the trailer 301 via a hinge 304 along the bottom of the door 302. A trailer door actuation system 300 comprises a first pulley 306A and a second pulley 306B coupled to the trailer 301; a first cable 308A passing through the first pulley 306A and tethered to the door 302 using first eye bolt 310A; a second cable 308B passing through the second pulley 306B and tethered to the door 302 using a second eye bolt 310B (while eye bolts are referenced, any securing means may be used); wherein each cable 308A, 308B is coupled, at the opposite end, to a reel 312A, 312B respectively (as shown in FIG. 8). Each cable 308A, 308B is wound around its respective reel 312A, 312B, with the reel 312A, 312B being actuated by a lever 314 that is motor or hand-crank controlled (not shown). The lever 314 actuates rotatable shaft 316, which in turn rotates both reels 312A, 312B. Therefore, a user may rotate the lever 314 in the desired direction, which winds or unwinds the cables 308A, 308B on the reels 312A, 312B respectively, which raises and lowers the door 302 accordingly. Like other embodiments, if using a motor to actuate the lever 314, a removable engaging switch (e.g., similar to the remote 114) may be used so as to prevent unauthorized use of the door 302. It is noted that the components on the underside of the trailer 301, such as the reels 312A, 312B, lever 314, and shaft 316 may be concealed within a housing to protect them from debris, etc.

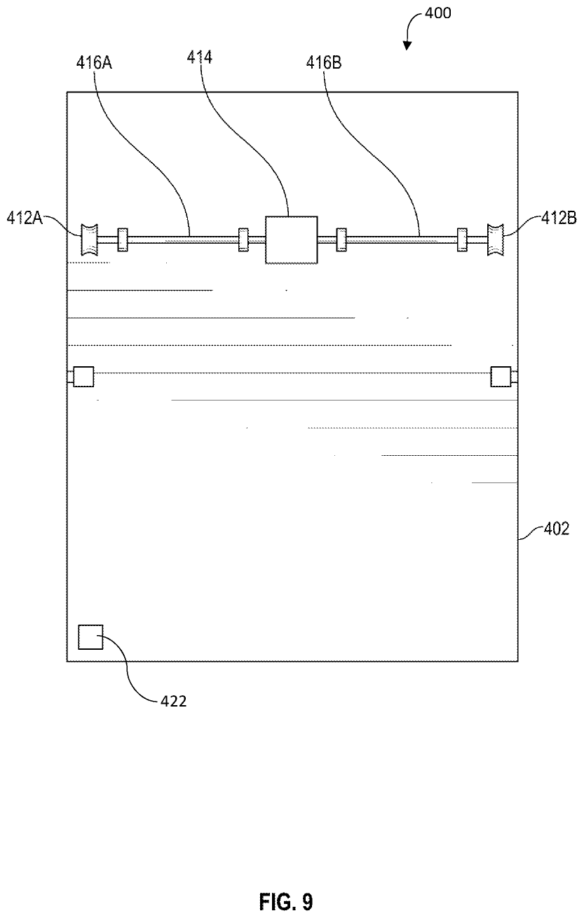

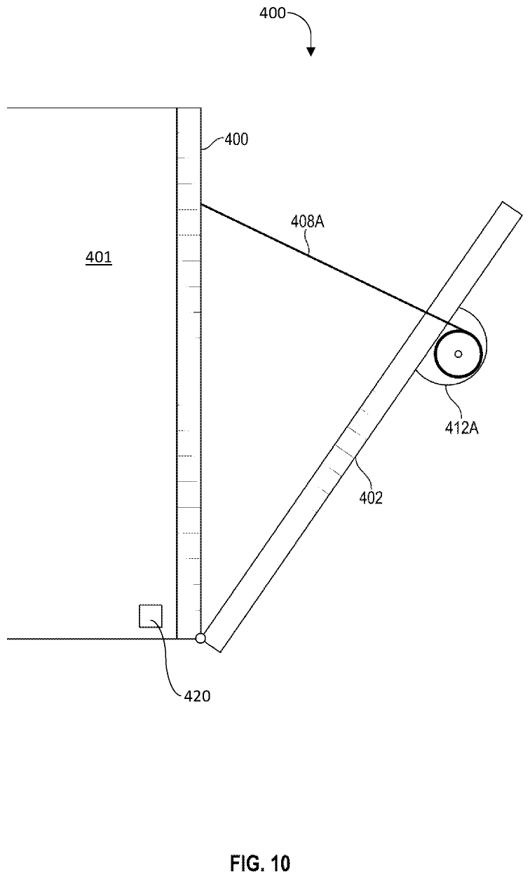

In another embodiment, the motor, shaft, and reel components may be coupled to the door instead of the trailer. For example, FIGS. 9-10 illustrate a trailer door actuation system 400 on trailer 401 wherein the door 402 comprises a first reel 412A and a second reel 412B. The motor 414 may be interposed between the reels 412A, 412B, which rotates shaft 416A, 416B, thereby winding and unwinding the cables 408A, 408B (cable 408B not visible) on reels 412A, 412B. It will be appreciated that the components on the door 402 may be covered for aesthetics, safety, and component integrity purposes. In one embodiment, the motor 414 may be actuated using the remote of FIG. 4. and connectors 420, 422 on the trailer 401 and door 402, respectively. This allows the system to be easily retrofitted to existing trailers without worry of running permanent wires from the trailer to the door. As discussed earlier, the remote of FIG. 4 also adds safety and security to the trailer. For example, without the remote, the door cannot be lowered, preventing unauthorized access. Further, by requiring a connection on the trailer 401, it helps to keep a user from lowering the door 402 when the user is beneath the door 402. This may be ensured by decreasing the length of the cable to the trailer such that the remote 114, when plugged into the trailer 401, cannot be underneath the door 402.

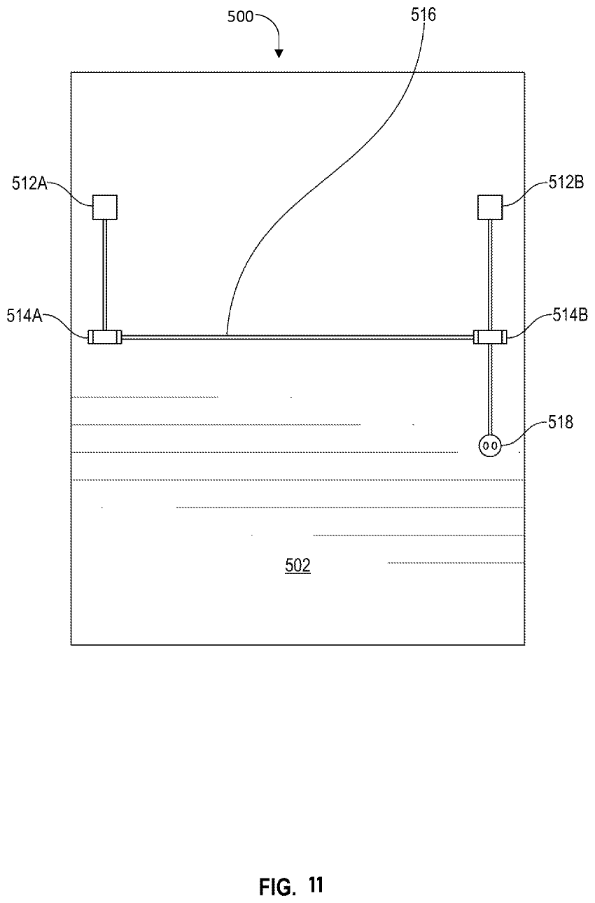

In yet another embodiment, as shown in FIG. 11, a plurality of winches 514A, 514B may be used to actuate the door 502. For example, FIG. 11 illustrates a door 502 of a trailer door actuation system 500 comprising a first motorized winch 512A, a second motorized winch 512B, a first latch 514A coupled to the first motorized winch 512A and a second latch 514B coupled to the second motorized winch 512B. The latches 514A and 514B must be open for the motorized winches 512A, 512B to be powered, ensuring that the door 502 remains squared. As in other embodiments, these motorized winches 512A, 512B may be controlled using a wired remote coupled to electrical port 518, which ensures safety and security.

While examples of a wired remote were used throughout, it will be appreciated that such remote is not required and that systems omitting the wired remote fall within the scope of this invention. For example, push buttons, toggle switches, keyed switches, touch screens, wireless remotes, and other controlling switches may be used with any of the motors described herein.

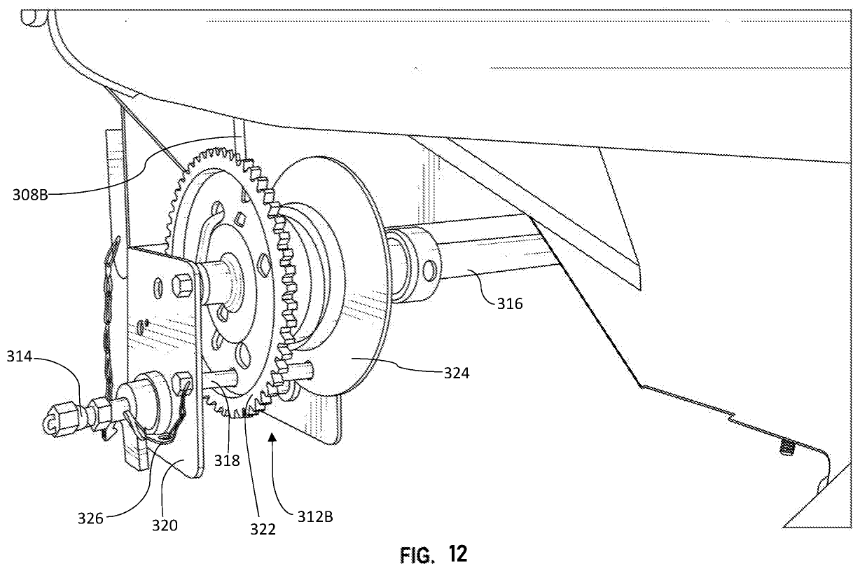

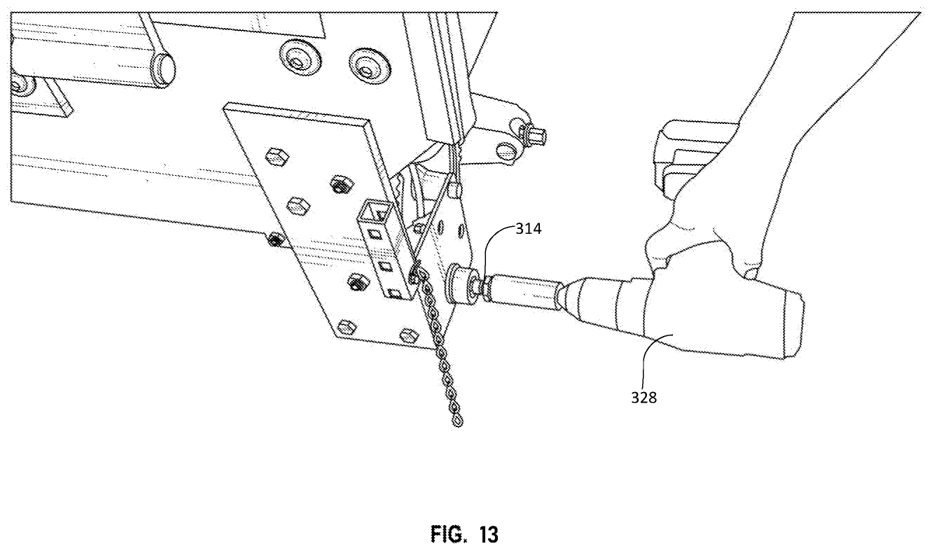

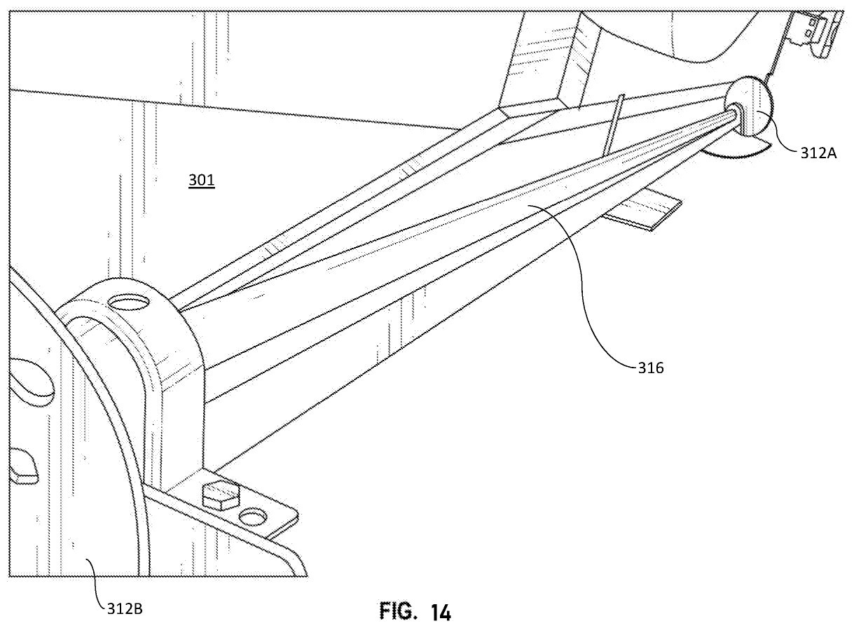

FIG. 12 shows a detailed view of the reel 312B of FIG. 8. As shown, the reel 312B is actuated by rotating lever 314, which rotates cogs that mesh with the cogs of first side 322 of the reel 312B accordingly. To prevent unwanted rotation, a locking pin 318 may be used. For example, the locking pin 318 may be secured through plate 320 and passes through the first side 322 and second side 324 of the reel 312B, thereby preventing rotation. To prevent loss of the locking pin 318, a tether 326 may be coupled thereto. In one embodiment, a handle (not shown) may be coupled to the lever 314 to rotate it. In another embodiment, as shown in FIG. 13, a powered hand tool 328 may be coupled to lever 314 for quick rotation thereof. As the reel 312B rotates, the cable 308B is wound or unwound thereon. Further, rotatable shaft 316 (FIGS. 8, 12, 14) ensures that booth reels 312A, 312B rotate equally, ensuring the door 302 remains squared.

Accordingly, it will be appreciated from the foregoing that the trailer door actuation system solves the need for a system of easily raising and lowering a trailer door or gate, that secures the contents thereof, and that is safe to use.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A trailer door actuation system, comprising:
a trailer door coupled to a trailer via a hinge along a bottom of the trailer door;
a first pulley coupled to a first side of the trailer and a second pulley coupled to a second side of the trailer;
a hoist; and
at least one cable coupled to the hoist and passing through the first and second pulleys;
wherein when the hoist is actuated in a first direction the cable is wound and when actuated in a second direction the cable is unwound.

2. The system of claim 1, further comprising a hand crank for actuating the hoist.

3. The system of claim 1, further comprising a motor for actuating the hoist.

4. The system of claim 1, further comprising a second hoist and a second cable, the second hoist coupled to the first hoist via a rotatable shaft.

5. The system of claim 1, wherein the hoist is secured to the trailer door.

6. The system of claim 5, further comprising a door pulley system.

7. The system of claim 1, wherein the hoist is secured to the trailer.

8. The system of claim 1, further comprising a trailer receptacle and door receptacle, and a remote comprising a trailer connector and door receptacle for coupling to the trailer receptacle and door receptacle, respectively, for electrically controlling the hoist.

9. A trailer door actuation system, comprising:
a trailer door coupled to a trailer via a hinge along a bottom of the trailer door;
a first pulley coupled to the trailer and a second pulley coupled to the trailer;
a first cable passing through the first pulley and tethered to the trailer door;
a second cable passing through the second pulley and tethered to the trailer door;
a first reel for winding the first cable and a second reel for winding the second cable, each reel secured to the trailer;
a rotatable shaft coupling the first reel to the second reel;
a lever for actuating the first reel, rotatable shaft, and second reel;
wherein when the lever is actuated in a first direction the first cable is wound on the first reel and the second cable is wound on the second reel, and when actuated in a second direction each cable is unwound from the first and second reel.

10. The system of claim 9, further comprising a motor for actuating the reels.

11. The system of claim 10, further comprising a wired remote, the remote comprising a trailer connector and a door connector, the trailer comprising a receptacle for receiving the trailer connector and the trailer door comprising a receptacle for receiving the door connector.

12. The system of claim 9, further comprising a hand crank for actuating the lever.

13. The system of claim 9, further comprising a locking pin for prohibiting rotation of the first and second reels.

14. A trailer door actuation system, comprising:
a trailer door coupled to a trailer via a hinge along a bottom of the trailer door;
a first reel secured to a first side of the trailer door;
a second reel secured to a second side of the trailer door;
a motor interposed between the first and second reels, the motor coupled to each reel via a rotatable shaft, the motor rotating the rotatable shaft, which in turn rotates the reels;
a first cable coupled to the first reel and tethered to the trailer;
a second cable coupled to the second reel and tethered to the trailer;
wherein when the motor is actuated in a first direction, each reel rotates in a first direction, winding the cables and thereby closing the trailer door on the trailer;
and wherein when the motor is actuated in a second direction, each reel rotates in a second direction, unwinding the reels and allowing the trailer door to open to the desired position.

15. The system of claim 14, further comprising a wired remote for controlling the motor, the remote comprising a trailer connector and a door connector, the trailer comprising a receptacle for receiving the trailer connector and the trailer door comprising a receptacle for receiving the door connector.

16. The system of claim 14, further comprising a locking pin for prohibiting rotation of the first and second reels.
